(19) United States
(12) Patent Application Publication
(10) Pub. No.: US 2024/0140037 A1
(43) Pub. Date: May 2, 2024

(54) APPARATUS AND METHODS FOR AUTOMATIC EXTRUDER CALIBRATION

(71) Applicant: Eric Draken, Vancouver (CA)

(72) Inventor: Eric Draken, Vancouver (CA)

(21) Appl. No.: 17/976,792

(22) Filed: Oct. 29, 2022

(51) Int. Cl. B29C 64/393; B29C 64/321; B29C 64/343

(52) U.S. Cl. CPC B29C 64/393; B29C 64/321; B29C 64/343; B33Y 50/02

(57) ABSTRACT

One embodiment of an extruder calibration apparatus for calibrating a reliable extruder assembly of a 3D printer includes an extrudent meter for measuring extrudent travel, a motor discriminator for counting extruder motor steps, a processor for calculating an extruder stepping rate, and a means for updating or facilitating an update of the associated 3D printer with the extruder stepping rate. Other embodiments are described and shown.

### CROSS-REFERENCE TO RELATED APPLICATIONS

This application claims the benefit of provisional patent application Ser. No. 63/409,750, filed Sep. 24, 2022 by the present inventor, which is incorporated by reference in its entirety.

### TECHNICAL FIELD

The disclosure generally relates to three-dimensional (3D) printing and/or additive manufacturing. More specifically, the disclosure relates to automating methods of extruder calibration to increase precision and layer adhesion in material-extrusion 3D printing.

### BACKGROUND ART

Three-dimensional (3D) printing, also known as additive manufacturing, is the action or process of making a physical object from a three-dimensional digital model, typically by laying down many thin layers of a material in succession.

One type of 3D printing is material extrusion. Material extrusion includes well-known processes such as fused filament fabrication, fused deposit modeling, and fused particle deposition whereby the model or part is fabricated by extruding small beads, pellets, filament, wire, gel, semi-solids, concrete, metals, cultured organic tissue, and/or streams of material which harden, dry, solidify, or fuse to form layers.

Most material-extrusion 3D printers employ stepper motors and/or servomotors to precisely adjust the travel (extrusion) of material to extrude (extrudent) in an assembly known as the extruder. The travel rate is known as the extruder stepping rate, or E-step herein, and is often expressed in steps/mm—the number of increments of rotation (steps) such a motor is expected to take to effect an extrusion of one millimeter of a given material by a given extruder assembly in a given environment. For example, an E-step of “93 steps/mm” is interpreted as expecting one millimeter of extrusion from ninety-three steps of a given stepper motor.

Accurate calculation of E-step prior to (and even during) part fabrication is essential to reduce the undesired material-extrusion phenomena of under-extruding and over-extruding. Non-calibrated extruders may lead to weak layer adhesion, inaccurate physical object dimensions, stringy parts, thatched surfaces, lack of print-bed adhesion, and/or total print failure.

The present accepted way to calculate E-step is manual, imprecise, and inconvenient, commonly involving a ruler, a marking instrument, repeated observations, and hand calculations. The present inventor has found that operators of 3D printers typically either rely on machine defaults, or calibrate the extruder(s) a few times over the lifetime of the 3D printer and compensate for unacceptable prints with sanding, melting, scraping, drilling, and other compensatory post-processing activities.

Since an extruder should be calibrated when the extruder is initially assembled, material is changed, upgrades are made, the climate changes, and periodically due to wear, yet the accepted method is inconvenient and imprecise, a need is present for an apparatus and methods for automatic extruder calibration.

### BRIEF SUMMARY OF THE DISCLOSURE

### Technical Problem

The present disclosure is made with the view of the above situation generally of inadequate and infrequent extruder calibration. An objective of the present disclosure is to provide an apparatus and methods whereby such extruder calibrations may be automated or semi-automated, depending on the embodiment, such that accurate and frequent extruder calibrations may be effected, and for one or more extruders of the same system.

### Technical Solutions

According to preferred embodiments of the present disclosure:
Devices for metering the flow extrudent are disclosed, as well as devices/cables/software for discriminating the increments of rotation (steps) of a related extruder motor;
By knowing accurately how many increments or steps an extruder motor takes, and how many units of travel such an extrudent flows, it is possible to calculate the E-step of an extruder—an objective of the disclosure: calculation of an extruder stepping rate;
A processing unit (herein called a processor), either external to, internal to, or comprising an existing extruder control system, may calculate such an E-step from the above information;
The E-step may be calculated on demand, semi-regularly, regularly, or continuously—an objective of the disclosure: frequent extruder calibrations;
The calculated E-step may be presented or reported to an extruder system operator by way of a display device whereby such an operator may adjust their operation according to the presented E-step value—an objective of the disclosure: semi-automated extruder calibration;
The calculated E-step may be transmitted to an extruder control system via wires or radio communication to instruct the extruder control system to update its E-step—an objective of the disclosure: automated, convenient, and semi-frequent extruder calibration; and
The calculated E-step may be calculated and updated within the extruder control system when the aforementioned processor is internal to or comprises the extruder control system—an objective of the disclosure: automated, convenient, and frequent extruder calibration.

### Advantageous Effects

According to the present disclosure, aspects of the disclosure may allow for accurate, automated, convenient, and frequent calibration of an extruder over the presently accepted manual, imprecise, and infrequent method.

A more complete understanding of the present disclosure, as well as further features and advantages of the disclosure, will be apparent from the following detailed description and the accompanying drawings.

### BRIEF DESCRIPTION OF DRAWINGS

The figures depict various aspects of the present disclosure for purposes of illustration only. One skilled in the art will readily recognize from the following discussion that alternative embodiments of the structures and methods illustrated herein may be employed without departing from the principles and spirit of the disclosure described herein.

Further, various components of the same type may be distinguished by following the reference label by a letter (for example, 180 and 180A) that distinguishes among the similar components. If only the first reference label is used in the specification, the description is applicable to any one of the similar components having the same first reference label irrespective of the following letter.

FIG. 1 is a perspective view of an extruder assembly and a filament-type extrudent meter according to an embodiment of the disclosure.

FIG. 1A is an enlarged perspective view of a filament-type extrudent meter according to an embodiment of the disclosure.

FIG. 2 is a perspective view of an embodiment of an alternate filament-type extrudent meter.

FIG. 2A is a perspective view of a possible relationship between an extruder assembly and a filament-type extrudent meter according to an embodiment of the disclosure.

FIG. 3 is a perspective view of an extruder assembly with an affixed rotary encoder according to an embodiment of the disclosure.

FIG. 4 is a perspective view of a cable splitter according to an embodiment of the disclosure.

FIG. 5 is a block diagram of a processor arrangement according to an embodiment of the disclosure.

FIG. 6 is a block diagram of a 3D printer mainboard and processor arrangement according to an embodiment of the disclosure.

FIG. 7 is a block diagram of an arrangement of multiple extruders according to an embodiment of the disclosure.

FIG. 8 is a block diagram of one embodiment of the disclosure.

FIG. 9 is a block diagram of an alternate embodiment of the disclosure.

FIG. 10 is flowchart of a procedure for automatic extruder calibration according to embodiments of the disclosure.

FIG. 11 is a block diagram of the relationships between various aspects of this disclosure with aspects bolded according to embodiments of the disclosure.

FIG. 12 is a block diagram of the relationships between various aspects of this disclosure with aspects bolded according to other embodiments of the disclosure.

REFERENCE NUMERALS

| | |
|---|---|
| 100 | Filament-type extruder assembly |
| 102 | Extruder motor shaft |
| 110 | Filament |
| 112 | Extruder motor |
| 114 | Motor connector |
| 140 | Motion translator assembly |
| 142 | Adjustable pressure lever |
| 143 | Spring |
| 144 | Receiver gear |
| 144A | Bearing |
| 146 | Flow guide |
| 148 | Motion translator body |
| 180 | Motion encoder |
| 182 | Rotary encoder |
| 184 | Connector |
| 186 | Encoder shaft |
| 200 | Optical rotary encoder |
| 202 | Receiver gear |
| 202A | Bearing |
| 204 | Optical slots |
| 206 | Optical encoder disk |
| 208 | Shaft |
| 210 | Optical sensors |
| 300 | Rotary encoder |
| 302 | Connector |
| 304 | Encoder shaft |
| 306 | Coupling sleeve |
| 400 | Cable splitter |
| 402 | Motor-side connector |
| 404 | Printer-side connector |
| 406 | Processor-side connector |
| 500 | SoC |
| 502 | Wires |
| 504 | Wires |
| 600 | 3D printer mainboard |
| 602 | OEM motor cable |
| 604 | Wires |
| 606 | Existing processor |
| 700 | SoC |
| 702 | Cable |
| 800 | SoC |
| 802 | Power supply |
| 804 | Display |
| 806 | Controls |
| 808 | Wires |
| 900 | SoC |
| 902 | USB cable |

### DETAILED DESCRIPTION OF PREFERRED EMBODIMENTS

The present disclosure may enable a reliable additive-manufacturing 3D printer to automatically or semi-automatically calibrate one or more given extruder assemblies for a given extrudent in a given environment, wherein calibration comprises: metering extrudent; discriminating extruder-motor steps; calculating E-step; and updating or facilitating an update of the associated 3D printer.

Example embodiments of the disclosure are described hereinafter in detail with reference to the attached drawings, wherein like reference numerals refer to like elements. The disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

Throughout, implementation suggestions and/or considerations may be supplied to aid in construction and understanding of one or more embodiments of the disclosure. It must be noted that whenever supplied, such suggestions/considerations are not to be construed as a nomination for a dominant embodiment, nor a narrowing of the scope of the disclosure.

Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Numbering terms such as “first”, “second”, or “third” can be used to describe various components, signals, values, or the like, which are for distinguishing one component/signal/value from another one only, and are not intended to, nor should be construed to impose any substantive limitations on the components, signals, values, or the like. Additionally, while “a/an/the” is used in this disclosure, this in no way limits the quantity of any component employed in an embodiment.

The subject headings used herein are included only for the ease of reference of the reader and should not be used to limit the subject matter found throughout the disclosure or the claims. The subject headings should not be used in construing the scope of the claims or the claim limitations.

Also, the terms “comprise”, “include” or any other variation thereof, are intended to express a non-exclusive inclusion, such that a process, method, article, or apparatus that comprises a list of elements not only include those elements but also may include other elements not expressly listed or inherent to such process, method, article, or apparatus.

Additionally, the terms used in the claims should be construed to have the broadest reasonable interpretation consistent with the forthcoming description. For example, the recitation of “or” should be interpreted as being inclusive, such that the recitation of “A or B” is not exclusive of “A and B,” unless it is clear from the context or the forthcoming description that only one of A and B is intended. Further, the recitation of “at least one of each of” should be interpreted as including one or more of each kind/category/aspect of listed entities. For example, “at least one of each of: A; B; and C” permits the configuration of “A, B, and C” as well as “A, A, B, C1, and C2”.

### Definitions

As used herein, the following terms and variations thereof have the meanings given below, unless a different meaning is clearly intended by the context in which such term is used.

“Extrudent” refers to the material that enters an extruder assembly and leaves the extruder assembly under controlled force, which may be, but is not limited to, thermoplastic filament, semi-liquids, pellets, powders, wet cement, and materials not invented yet.

“Filament” refers to a tubular strand of extrudent, usually comprising thermoplastic.

“Extruder” refers to an assembly comprising a motor and a mechanism to transfer force from the motor to urge the extrudent in a controlled manner, and may be used interchangeably with “extruder assembly” where the context allows.

“Discriminate” refers to the action of differentiating and/or recognizing a distinction, particularly with respect to each step of a stepper motor.

“Encode” refers to the action of representing a physical manifestation, state, degree, and/or condition in a way that is characterized by a code representation, often, but not required to be, digital.

“Rotary encoder” refers to a device that may convert the relative position, angular position, transitory motion, or motion of a shaft or axle to analog or digital output signals.

“Gearing” refers to an assembly of usually toothed gears designed to transmit motion and/or convert torque and speed.

“Gear” refers to a rotating circular machine part that may or may not have teeth and/or grooving, which includes, but is not limited to, spur gears, helical gears, bevel gears, miter gears, worm gears, screw gears, rack gears, eccentric gears, cog gears, and impeller gears.

“3D printer” refers to the machine, motors, extruder(s), wires, power supply, heaters, fans, processor, software, firmware, and any and all facilitating structure, tubes, electronics, controllers, frame, display, controls, and the like that may be involved in the process of fabricating a three-dimensional part from successive layers of extrudent, and includes emerging technologies which may deposit non-planar layers (so-called 4D printers).

“3D printer mainboard” refers to the processing and motor-controlling electronics of a 3D printer, whether disposed internally or externally to a 3D printer, and/or in a single component “mainboard” or separated into disjoint electronics functioning together.

“G-code”, short for “Geometric code”, refers to the widely used computer numerical control (CNC) programming language adopted by the general majority of 3D printer systems.

“Connect”, and conjugations thereof, when used in the context of electronics, refers to purposeful and organized electrical wiring, cabling, soldering, inserting, bridging, joining, and other physical manifestations for enacting electrical pathways to facilitate the useful interoperation of two or more electronic devices, without inference or preference to the permanency or removability of such physical manifestations, which may be used interchangeably with “operatively coupled” unless clear from context otherwise.

“Firmware” refers to the instructions of a computer-processing device and may be used interchangeably without distinction with “program”, “software”, “source code”, “machine code”, “computer program code”, and/or “code” unless otherwise stated.

“E-step” refers to a given extruder assembly stepping rate for a given extrudent in a given environment, herein measured in steps-per-millimeter without loss of generalization.

“Travel” refers to motion in a generally predictable and regular way, and may be used interchangeably with “flow”, “displacement”, and/or “extrusion” when the context allows.

“Regular motion” refers to predictable and simple motion such as rotary motion, linear motion, oscillatory motion, and rectilinear motion, and includes displacement from a reference frame and/or a return toward such a reference frame (for example, clockwise and counter-clockwise rotation).

“Embodiments” refers to embodiments of the present disclosure as a whole, even when recited in the context of a variation, example, component, and/or aspect of the present disclosure.

### ASPECTS OF THE DISCLOSURE

There are four key aspects of this disclosure: metering extrudent flow, discriminating extruder-motor steps, calculating E-step, and actioning on E-step. Embodiments of all four aspects, whether physical or computational, are required to achieve the stated goals and advantages of this disclosure. To this end, disclosure of embodiments of each aspect follows, with subsequent aspects building on previous aspects so a complete disclosure may emerge.

In most embodiments of the disclosure, a device for metering extrudent flow (an extrudent meter) exists and may present as variations that are similar in nature and purpose. As such, an extrudent meter is divided into two distinct aspects of merit: a motion translator, and a motion encoder.

Therefore, embodiments of the disclosure are described as purposeful combinations of variations of the following five aspects: a motion translator; a motion encoder; a motor discriminator; a processor; and actioning. Additionally, methods of calculating E-step are disclosed.

### Aspects—Motion Translator

As a first aspect, a motion translator in this disclosure is characterized by at least one movable machine part, for example, a gear or piston. The at least one movable machine part comprises a suitable material (for example, stainless steel, rubber, or PTFE) which may be in contact with an extrudent so that travel of the extrudent urges a predetermined and regular motion of the motion translator. The purpose of the motion translator is to effect a proportional motion on the at least one movable machine part by the travel of the extrudent such that it is trivial for someone skilled in the art to encode the translated movement. Expanding on the above, a motion translator assembly is characterized by an operative coupling between a stationary machine part and the at least one movable machine part. With such an assembly, travel of the extrudent can thus be proportionally encoded allowing for metering of the extrudent.

To conceptualize the above, a gear or bearing whose rotational axis is perpendicular to a filament-type extrudent and whose body is in sufficient tangential contact with that extrudent may rotate as that extrudent travels, so it can be said that the linear motion of the extrudent is translated to the rotational motion of the gear/bearing.

As another conceptualization, a piston or plunger acting on a non-solid extrudent in a syringe-type extruder assembly may inherently function as a motion translator because the travel of the extrudent and the travel of the piston/plunger are proportional and regular.

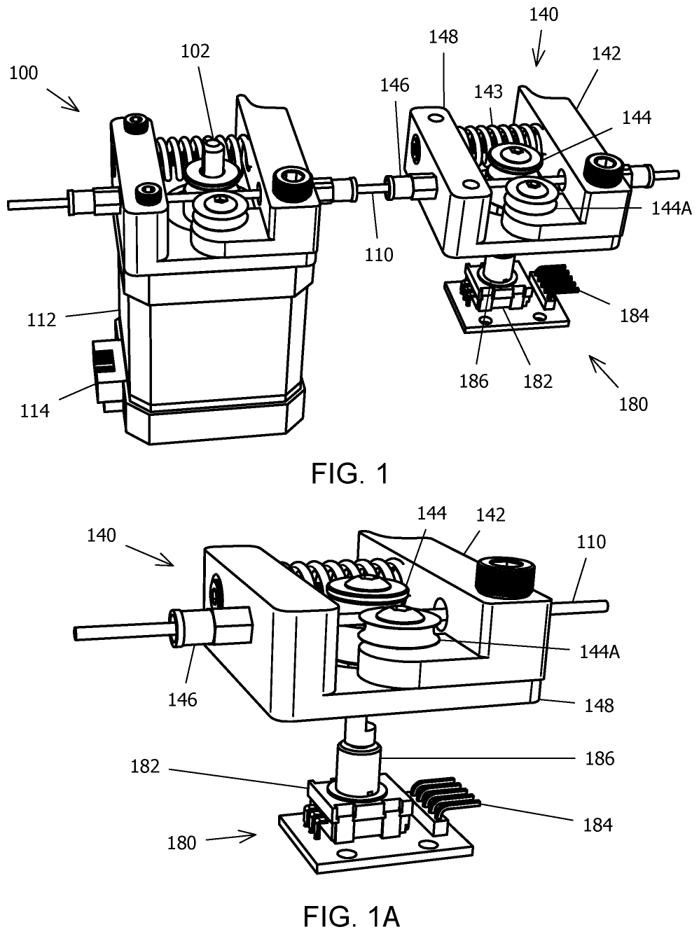

### FIG. 1-1A—Motion Translator Assembly, Motion Encoder, and Relation to Extruder

Referring to FIG. 1 as an illustration of an embodiment, a motion translator assembly 140 is shown. Motion translator assembly 140 is similar in function and organization to a filament-type extruder assembly 100 without an extruder motor 112. A receiver gear 144 serves as a motion translator. Here, receiver gear 144 and a bearing 144A with an adjustable pressure lever 142, biased by a spring 143, sandwich a filament 110. As filament 110 passes through a flow guide 146, receiver gear 144 rotates proportionally to the flow of filament 110. References to more elements in this illustration are forthcoming in subsequent sections.

It should be noted that where increased accuracy is desired, a given motion translator may incorporate a gearing mechanism (not shown) to effect a gear ratio such that the motion translator moves at a rate of a multiple of the travel rate of the extrudent. The advantage is that the motion translator may be more sensitive to extrudent travel than in non-gearing embodiments, thus leading to an improved metering accuracy. Without loss of generality, gearing is an anticipated feature of all embodiments where such gearing makes sense.

In other embodiments, a motion translator resembles a “pump vane” or a dual-gear pump (without any motor), such that flow of liquid or semi-liquid extrudent passes through such a motorless pump to again translate a linearly traveling extrudent flow into proportional rotational motion. These embodiments are thus applicable to wet-cement extruders used to fabricate some homes, for example.

In other embodiments, an existing plunger of a plunger-type extruder also makes a viable motion translator even though the displacement of the extrudent and the plunger generally travel in the same direction. As a variation of the previous, such a plunger may be part of a gear rack (visualized as an unrolled cogwheel). This modified plunger may then interface tangentially with a cogwheel in order to translate, again, linear motion of the plunger (and extrudent) into proportional rotational motion.

In other embodiments, an existing auger of a corkscrew-type extruder—for compacting powdered and pelleted extrudent—also makes a viable motion translator since the degree of rotation of the auger is generally proportional to the displacement of such extrudent. This mode of operation makes the most sense when the rotation of the auger is observed at a point after all drive gearing has taken place.

It should be noted that mechanisms to adjust pressure on a given extrudent in order to (1) minimize resistance to extrudent travel, and (2) ensure extrudent doesn't “slip” past a given motion translator, for example adjustable pressure level 142 and spring 143 to bias extrudent 110 toward receiver gear (motion translator) 144, are implied to be included in embodiments implicitly.

### Aspects—Motion Encoder

As a second aspect, a motion encoder in this disclosure is characterized by an electronic device configured to at least signal an incremental motive transition along a regular path, for example, in an incremental rotary or linear encoder. With such a characterization, it should be noted that a motion encoder is not required to encode an absolute position, an absolute angle, nor a velocity; a motion encoder should at a minimum signal an incremental change of position. For example, if the motion encoder is rotational in nature, one such implementation may signal every one degree of rotation.

Referring to FIG. 1A as an illustration of an embodiment, there is a motion encoder 180 comprising an electro-mechanical rotary encoder 182 connected by an encoder shaft 186 to receiver gear 144. The body of motion encoder 180 is generally secured to a motion translator body 148 with a support structure, enclosure, or a housing (not shown). The active moving machine parts are then receiver gear 144, bearing 144A, and encoder shaft 186 of rotary encoder 182. Receiver gear 144 (and bearing 144A) rotates as filament 110 passes. Encoded signals representing increments of rotation may appear on an electronic connector 184.

### Motion Encoder—Travel Calculation

Still referring to FIG. 1A, given the diameter (d) of receiver gear 144 and given the well-known circumference formula (pi×d), and dividing the circumference by the number of incremental steps (segments) in a full rotation of encoder shaft 186 of rotary encoder 182, the counted incremental steps directly correspond to the travel of filament 110. For example, if the diameter of receiver gear 144 is 22.92 mm, and the number of steps of rotary encoder 182 is twenty-four steps, then the travel of filament 110 by 1 mm is encoded by 3.00 steps.

As an implementation suggestion, an electro-mechanical rotary encoder with generally four encoded values to indicate direction of rotation (00, 01, 10, and 11) may be employed because such rotary encoders are commonplace (for example, as volume controls). It is recommended to use such a rotary encoder with a higher angle resolution than that of an inexpensive commercial rotary encoder where resolutions of twenty-four “pulses” per revolution (PPR) are typical, yet such a typical resolution of twenty-four PPR results in an angle resolution of only fifteen degrees. Otherwise, gearing may be incorporated into an embodiment to increase the sensitivity of the rotary encoder.

As another implementation suggestion, contact-type electro-mechanical rotary encoders have a feature known as detent. A detent is a “stop” or notch at which a rotary encoder may rest between increments of rotation. It is recommended to employ such a rotary encoder with either many detents to reduce the perceived notching, or employ such a rotary encoder without detents for a smoother rotation. Such rotary encoders are included in embodiments of this disclosure.

Other types of rotary encoders are advantageous in embodiments, such as non-contact rotary encoders (optical, capacitive, and magnetic types, for example) whose class-advantage is reduced friction imposed by such a rotary encoder on the motion translator (and extrudent). Case in point, optical rotary encoders generally have no detents and may spin freely, generally limited by the resistance of the bearing on which they spin (while extrudent is not present).

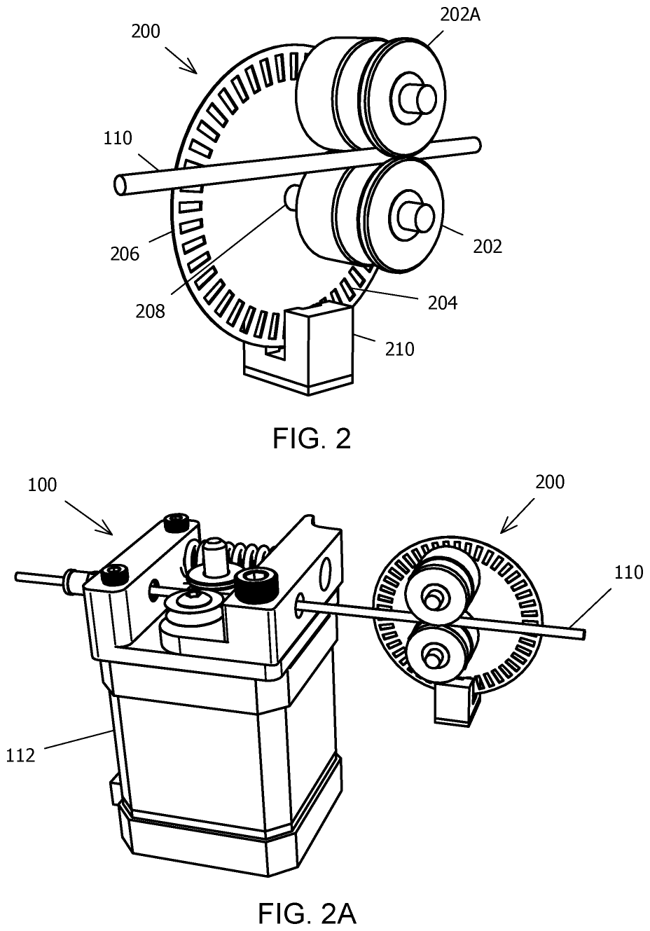

### FIG. 2-2A—Optical Rotary Encoder and Relation to Extruder

Referring to FIG. 2 as an illustration of an embodiment, an optical encoder disk 206 of an optical rotary encoder 200 may be axially aligned with, and directly affixed to, a motion translator when the motion translator is, in principle, a type of gear 202 and/or a spinning shaft 208 if such an arrangement warrants. The optical sensors 210 are not physically in contact with optical encoder disk 206, so the majority of the (reduced) rotational friction on optical encoder disk 206 should be due to any bearings (not shown) that structurally support gear 202 (and a gear 202A) in contact with filament 110. Reduced friction is desirable to minimize an embodiment from physically influencing 3D print quality from, say, dragging of the extrudent.

It should be noted that the detailed illustration of motion translator assembly 140 has been distilled herein to mere gears (202, 202A) to focus the reader's attention on other aspects of a given embodiment, such as optical rotary encoder 200. In subsequent illustrations, such a distilled view of the motion translator assembly will persist.

It should be noted that the resolution of optical (slot-type) encoder disk 206 might be controlled such that an increase in size (area) of optical encoder disk 206 can afford more optical slots 204 and thus feature a proportionally increased angle resolution. It is advised that in such embodiments, a person skilled in the art should implement optical rotary encoder 200 with at least the same angular resolution of that of a typical stepper motor used in 3D printers so that extrudent metering may be at least as precise as extruder motor discrimination (discussed shortly).

It should be further noted that additional subclasses of rotary encoders exist comprising absolute and incremental rotary encoders, both being equally viable for, and exist in, embodiments of this disclosure as both are capable of encoding increments of rotation. However, it is generally understood that incremental rotary encoders tend to have a higher angular resolution than absolute encoders owing to the simplicity of the general encoding scheme (often Gray code), whereas absolute rotary encoders, by definition, encode each incremental angle uniquely. For example, to uniquely encode 256 angles (a resolution of 1.4 degrees) requires eight bits of encoding that may be thought of as eight optical sensor signals coupled to an optical encoder disk with 256 unique patterns—this incurs production cost. Therefore, incremental rotary encoders are recommended for commercial purposes.

In other embodiments, a device that is reconfigured to behave as a rotary encoder is employed: a stepper motor. Distinct from the extruder stepper motor, another stepper motor may behave as a rotary encoder owing to the fact that as an unpowered stepper motor rotates, such a stepper motor produces detectable voltages on the motor windings in a predictable pattern that may allow inference of the motor rotation steps taken. This is advantageous because an existing extruder assembly from another 3D printer may be economically repurposed as both a motion translator and a motion encoder whereby the traveling extrudent urges the repurposed stepper motor, and not the other way around. A person skilled in the art will be able to employ clipping diodes and high-voltage transistors, for example, to normalize the range of voltages that may be observed under this implementation.

In other embodiments, a linear encoder is employed when the extruder is a plunger-type or syringe-type. This allows the present disclosure to be applicable to emerging 3D printer technologies such as in biomedicine and low-gravity 3D printing. Types of linear encoders are numerous and well known by those skilled in the art.

To summarize, the purpose of the previous two aspects—a motion encoder combined with a motion translator, such as illustrated in FIG. 1A and FIG. 2—is to enable embodiments to accurately meter the travel of extrudent in a device referred to as an extrudent meter.

It should be noted that embodiments may include a housing to mostly enclose the combination of a motion translator assembly and a motion encoder, when applicable (for example, as a filament-type extrudent meter), to protect the internals from the elements and to operatively secure any stationary parts of the motion translator assembly (for example, motion translator body 148) and the motion encoder (for example, rotary encoder 182) together. Such a housing may further comprise a means to permit the housing to be operatively affixed to a participating 3D printer, such as to the 3D printer frame, or to the participating extruder assembly. The housing may allow for voids and/or flow guides so that extrudent may enter and exit the housing.

### Aspects—Motor Discriminator

As a third aspect, a motor discriminator in this disclosure is characterized by an electronic device or system that can discriminate, infer, or calculate predetermined increments (steps) of rotation of an extruder motor. In general, consumer and industrial 3D printers employ stepper and/or servomotors, so a reliable motor discriminator should discriminate the individual steps that a given stepper and/or servomotor may take. Even plunger-type extruders often employ stepper motors. Herein, a recitation of “stepper motor” shall include servomotors implicitly. A motor discriminator discriminates the increments of rotation (steps) of an extruder motor in a unit of steps. The number of cumulative steps over a period of several seconds may be observed. An active extrudent meter over the same period of several seconds may also be observed to calculate the cumulative distance some extrudent has traveled, usually in millimeters. An extrusion rate (extruder stepping rate or E-step) in steps-per-millimeter thus may be calculated.

In some embodiments, a motor discriminator may be, for example, another rotary encoder that shares a common shaft with the extruder motor. Such an arrangement may also comprise gearing so as to make the rotary encoder more sensitive to motor stepping. To reiterate, such a rotary encoder is not limited to recited examples in this disclosure, and may be optical, capacitive, magnetic, inductive, incremental, absolute, a stepper motor repurposed to act as a rotary encoder or a rotary encoder not yet in existence.

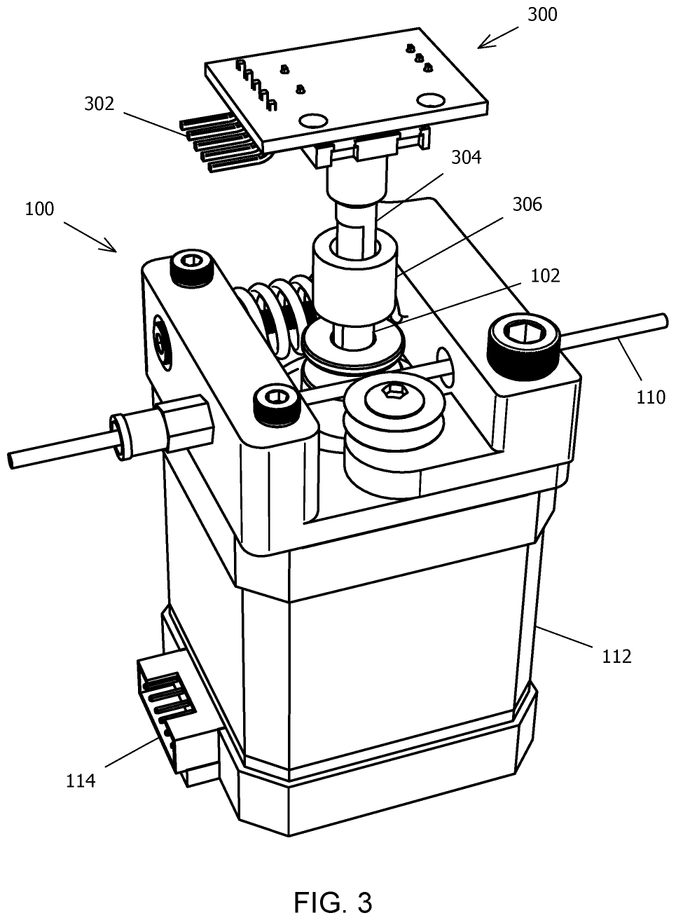

### FIG. 3—Rotary Encoder as Motor Discriminator

Referring to FIG. 3 as an illustration of an embodiment, a rotary encoder 300 shares an axis and an encoder shaft 304 with an extruder motor shaft 102 of extruder motor 112 by way of a coupling sleeve 306. The body of rotary encoder 300 is fixed to, say, filament-type extruder assembly 100 or stepper motor 112 with some support structure (not shown). As filament 110 travels, the steps of extruder motor 112 may be directly observed (discriminated) and encoded by rotary encoder 300. The advantage of this arrangement is that such embodiments electrically isolate a motor connector 114 of stepper motor 112 from a connector 302 of the motor discriminator (rotary encoder 300) to reduce the electrical complexity of said embodiments.

In other embodiments, a motor discriminator may involve cable-splitting of the typically four-to-six electrical wires normal to a stepper motor to observe the pattern of voltages applied to the coils in the stepper motor imparted by a 3D printer mainboard. Such observations permit the inference of motor steps because coil-energizing patterns are well known. The advantage of such embodiments is that a cable splitter is economical and may be adapted to retrofit existing 3D printers.

It should be noted that motor coil voltages generally should be attenuated and normalized so that logical circuits and devices may act on them safely. A person skilled in the art will be able to employ clipping diodes, high-voltage transistors, optocouplers, and the like to achieve such voltage (signal) attenuation.

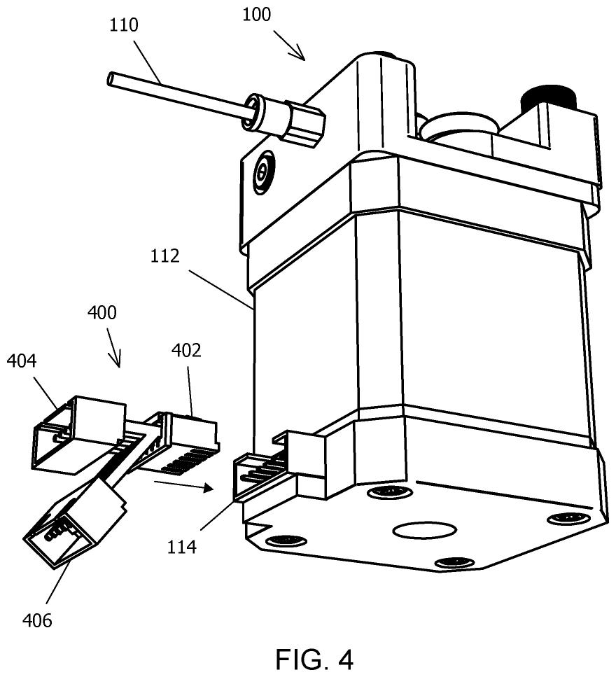

FIG. 4—Cable Splitter as Motor Discriminator

Referring to FIG. 4 as an illustration of an above embodiment, a cable splitter 400 is depicted. An existing Original Equipment Manufacturer (OEM) extruder motor cable (not shown) connects to a printer-side connector 404. The original extruder electrical pathways are restored by inserting a motor-side connector 402 into motor connector 114 as indicated by the arrow. Herein, the 3D printer should operate as before. Coil-energizing patterns may be observed via a processor-side connector 406 (after appropriate attenuation, not shown). FIG. 4 depicts the use of JST (Japan Solderless Terminal) connectors because, in general, consumer 3D printers utilize JST connectors. It should be noted that embodiments are not limited to any connector type.

It should be noted that some 3D printers employ standardized motor cable, but with two or more wires crossed over along the way to accommodate proprietary motor controllers. Therefore, it is recommended to employ a straight-through wire configuration for the cable splitter (as shown in FIG. 4) with no wires crossing over, and continue to use the existing OEM extruder motor cable (not shown) between the 3D printer mainboard (not shown) and printer-side connector 404 of cable splitter 400.

Cable splitter 400 depicts a suggested design that is economical and may fit most existing stepper motors. However, there are variations of “cable-splitting” that may achieve the same purpose, so all such techniques of observing the pattern of voltages applied to the extruder motor coils are included in embodiments and in claims.

In other embodiments, an extruder motor with an in-built rotary encoder may be employed. These motors are typically stepper motors, but are not required to be. For example, some brushless motors achieve a predetermined degree of angular precision with a feedback loop from an in-built rotary encoder. The advantage of such embodiments is that they may allow 3D printers with brushed or brushless extruder motors to still calibrate their extruders, as well as generally allow the rotary encoder to be electrically isolated from the stepper motor.

In other embodiments, a motor discriminator may already exist: a 3D printer mainboard generally has a processor and embedded or external motor controllers. Such a system may be interacted with programmatically to observe every instruction for an extruder motor. Since the above processor instructs each step that an extruder takes, it is advantageous to trivially query the 3D printer control system with deliberate programming to effect a motor discriminator. A person skilled in the art should be able to modify some well-known and generally open-source 3D printer control software and add a code block to, say, read the extruder step instruction each time one is executed (and then compile this code into firmware and upload it to a given 3D printer). Reading of step instructions may be achieved in a control loop or with processor interrupts (IRQs), for example. The advantage with these embodiments is that reduced hardware is required over the previous rotary encoder and signal-splitter embodiments.

### Aspects—Processor

As a fourth aspect, a processor in this disclosure is essentially a device or apparatus that is configured to observe and process (attenuated) signals/values from a motion encoder and a motor discriminator (which may be software) over an overlapping period of time (or after a threshold number of motor steps taken). Such a processor may then at least calculate an E-step either on demand, at predetermined intervals, or continuously, using well-known statistical methods (for example, a rolling average).

In some embodiments, the processor may be generally characterized as a microcontroller, a single-board computer, or a system-on-a-chip (SoC) with general-purpose input-output (GPIO) hardware interfacing embedded. Herein, the term SoC is used as a convenience for the reader, but this is not intended to be limiting because the “system” of system-on-a-chip is broad enough to encapsulate any and all necessary system features such as, but not limited to, architecture, number of cores, CPU frequency, RAM, cache, flash, PROM, radio, UART, Serial Peripheral Interface (SPI), GPIO, networking, and the like. SoCs are well documented and widely used owing to their ease of programming, and typically tolerate ranges of input voltages.

It should be noted that a SoC is accompanied by an appropriate power supply and input-output (I/O) interface. A person skilled in the art may select, connect, and configure such a processor, power supply, and I/O according to embodiments, and as such, no special endorsement of a type of processor is put forward as alluded to in the preceding paragraph.

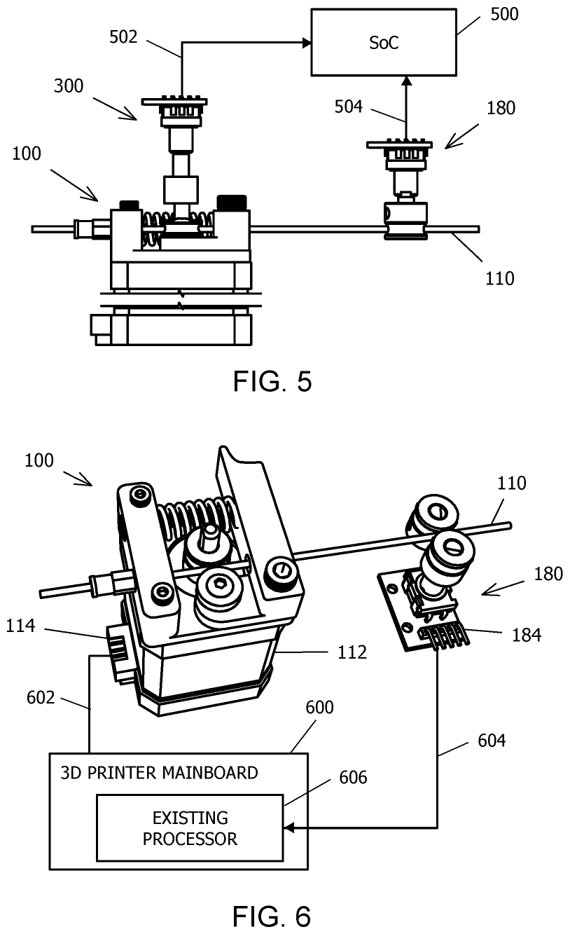

FIG. 5—Processor with Multiple Rotary Encoders Embodiment

Referring to FIG. 5 as an illustration of an above embodiment, an SoC 500 may read encoded values from two rotary encoders: one from motion encoder 180 (see FIG. 1A) connected to SoC 500 via first wires 504, and one from motor discriminator 300 (see FIG. 3) connected to SoC 500 via second wires 502. Regarding such first and second wires, interfacing each respective rotary encoder to SoC 500 may trivially be accomplished by connecting the appropriate rotary encoder signal pins (and ground pin) to SoC 500 on GPIO pins (not shown) with appropriate current-limiting resistors (not shown) in place as needed. A person skilled in the art should generally be able to write and compile source code to read and decode such encoded values on GPIO pins in a program loop to calculate E-step. An example program flowchart will be described, shortly.

In other embodiments, instead of a rotary encoder as a motor discriminator, the cable-splitting technique disclosed previously (see FIG. 4 and Aspects—Motor Discriminator) is employed as a motor discriminator. The advantages again are a reduced hardware footprint, and little or no need to modify an existing extruder.

In other embodiments, the processor and the motor discriminator may already be present as part of an existing 3D printer and system thereof. Case in point, 3D printer mainboards generally have a processor that directs multiple motor controllers to operate in a given 3D printer, and 3D printer mainboards generally have external ports, accessories ports, or even a SPI port to connect to external devices such as bed-leveling sensors. Some embodiments leverage such an existing 3D printer mainboard as a processor (with respect to this disclosure) with firmware modification.

### FIG. 6—3D Printer Mainboard as a Processor Embodiment

Referring to FIG. 6 as an illustration of an above embodiment, a slightly modified 3D printer firmware executes on an existing processor 606 of a cooperating 3D printer mainboard 600. Existing processor 606 may be capable of reading each instructed step (as a motor discriminator in software) of extruder motor 112 (shown here connected via OEM motor cable 602). Existing processor 606 may also, for example, process the values/signals of motion encoder 180 (as an extrudent meter) connected via connector 184 to at least one of the external ports of 3D printer mainboard 600 (with appropriate current-limiting resistors, not shown) via wires 604.

Since the modified firmware is already reading each instructed motor step, and 3D printer mainboard 600 is operatively connected to motion encoder 180, it should be straightforward to extend the firmware to also calculate E-steps using well-known statistical methods (for example, a rolling average). A person skilled in the art is generally able to modify, write code to read external port values (typically also GPIO), and compile well-known 3D-printer open-source code into such firmware.

The above embodiment has the advantage of using an existing 3D printer system to reduce the hardware footprint of the embodiments. Existing 3D printers may be retrofitted, and may allow existing 3D printers to incorporate additional features, such as but not limited to: setting the frequency of calibrations; showing the history of E-steps; changing the statistical methods to calculate E-step; performing an alert if consecutive E-step calculations differ by a predetermined threshold; and disabling E-step calibration if desired.

### Processor—Multiple Extruders

All of the disclosed embodiments apply well to 3D printers with multiple extruders since multiple extruders generally comprise multiple extruder motors. Someone skilled in the art should be able to organize and configure a SoC for multiple motion encoders and multiple motor discriminators. Embodiments for calibrating multiple extruders are disclosed in detail, next.

In some embodiments, especially where the processor and the motor discriminator “live” as part of an existing 3D printer, someone skilled in the art should be able to: use multiple external ports (if available); and/or employ a simple n-for-one multiplexor circuit to share two or more motion encoders with a single external port.

Such a multiplexor circuit is common, and is used, for example, to increase the number of GPIO pins available to a processor by time slicing each multiplexed GPIO pin. Such multiplexing is also suitable for reading input from motion encoders. As long as the time slices afforded to each motion encoder by the processor are adequately brief and sufficiently frequent, a predetermined resolution of observation may be achieved such that no “missed” motion of any motion encoder is experienced. Time slices on the millisecond scale are generally sufficient. The advantage of these embodiments is that only a single multiplexor circuit (typically as a single integrated circuit chip) is generally required to support multiple extruders (plus source code modifications for the processor time-slicing aspect).

In some embodiments especially suited to multiple extruders, an advantageous processor configuration is a hybrid of an existing 3D printer mainboard and a SoC. As discussed previously, a SoC makes a versatile processing solution in typically just one integrated circuit. As such, it is advantageous to utilize a SoC as a pre-processor for one or more motion encoders (and possibly one or more cable splitters or encoder-based motor discriminators) in order to substitute for the multiplexor configuration above and alleviate the processing overhead entailed in time-slicing.

Someone skilled in the art may configure a SoC to: electrically connect to the aforementioned encoders or cable splitters (with voltage attenuation) from the GPIO leads of said SoC; decode the signals (values) of such motion encoders and/or motor discriminations as described previously; and ready “normalized representations” of such values for the 3D printer mainboard in order for the 3D printer mainboard to perform the E-step calculations.

To elaborate on “normalized representations”, suppose, for example, four 2-bit rotary encoders are employed for calibrating two extruders. A bit-representation of all four encoders may require eight bits. Instead of electrically connecting nine wires (eight bits plus ground) from the SoC to the 3D printer mainboard, the SPI protocol, which is generally common to 3D printers, may be employed which should utilize just four well-known wires (MISO, MOSI, SCLK, and ground). Therein, an 8-bit payload may be in essence sent to the 3D printer mainboard (typically in so-called slave mode) via the SPI protocol when any of the four rotary encoders experience a change. Thus, the 8-bit payload is a normalized representation of the states/values of the four rotary encoders.

As an implementation suggestion of the above, the SPI protocol may be implemented with an interrupt system (IRQ), so, for example, while the 3D printer mainboard is in SPI slave mode, upon reception of an update from the SoC to the 3D printer mainboard, an interrupt service routine (ISR) may update volatile variables in the memory of the 3D printer mainboard processor. As such, the firmware of the 3D printer mainboard may direct the processor to act on such variables to calculate E-steps (plural, in this example) at an appropriate time for the 3D printer.

It should be noted that it is a natural evolution for the SoC described above to perform E-step calculations entirely in itself and then send all updates of one or more E-steps to the 3D printer mainboard (for example, via the SPI protocol).

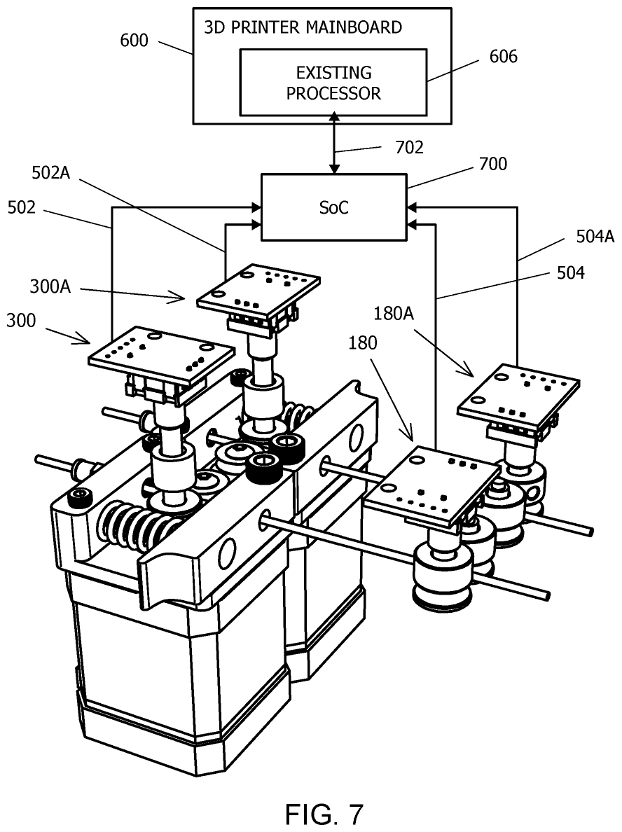

### FIG. 7—Multiple Extruders Embodiment

Referring to FIG. 7 as an illustration of an above embodiment, an SoC 700 may have bidirectional communication with 3D printer mainboard 600 (and existing processor 606) via a cable 702 over the SPI protocol (as an example protocol). SoC 700 accepts electrical input signals via first wires 502/502A from each motor discriminator (rotary encoder 300/300A). SoC 700 also accepts electrical input signals via second wires 504/504A from each motion encoder 180/180A. The firmware of existing processor 606 may request the current E-steps from SoC 700 on demand or periodically. Alternatively, SoC 700 may calculate the current E-steps continuously (for example, with a rolling average), and send those E-steps as unsolicited updates to 3D printer mainboard 600 (and existing processor 606) at a predetermined interval. It should be noted that a depiction of support structure for the rotary encoders has been omitted for clarity. The advantage of this embodiment is that multiple E-steps may be calculated with a reduced burden on the 3D printer system versus a multiplexing-type embodiment.

### Aspects—Actioning

As a fifth aspect, actioning in this disclosure is characterized as a useful action performed with a valid E-step after such an E-step is calculated for the goal of calibrating a given extruder assembly.

Here is an a non-exhaustive list of useful actions a valid E-step may undertake: reported visually in a display; indicated with Braille dots; reported audibly in an announcement; transmitted to a participating 3D printer; automatically updated in a participating 3D printer; made available in a kind of web interface; transmitted to an intermediary control system; written to a portable storage for logging; and compared with an existing E-step value to display a warning if the difference is larger than a predetermined threshold.

As can be seen, there are numerous embodiments of this disclosure with respect to actioning. As such, the present inventor is disclosing three exemplary embodiments. Variations of the following should therefore be anticipated.

### Actioning—Displaying E-steps

Actioning in the following embodiments is characterized as presenting a calculated E-step to some operator of a given 3D printer for such an operator to act on. In embodiments where the disclosure employs a SoC, such embodiments may have a visual display (for example, and not limited to, LCD, TFT, and OLED) for displaying the current E-step of a given extruder motor. Such embodiments may have a touch interface incorporated with the display (capacitive or resistive), and/or have one or more physical buttons or input controls for functions such as powering, calculating, resetting, pausing, and the like.

A person skilled in the art may employ a parallel data connection to connect such a display (and/or controls) to the SoC via GPIO leads, and connected via a ribbon cable or soldered proximally to the SoC. It is preferred to use the SPI protocol and a serial data cable (cable or directly soldered) to connect such a capable display (and/or controls) to the SoC as the SPI protocol is well-understood and simplifies the hardware with its fewer wires over a parallel connection. The advantage of these embodiments (with a display) is that the disclosure may be made portable and thus useful for calibrating extruder assemblies of multiple 3D printers.

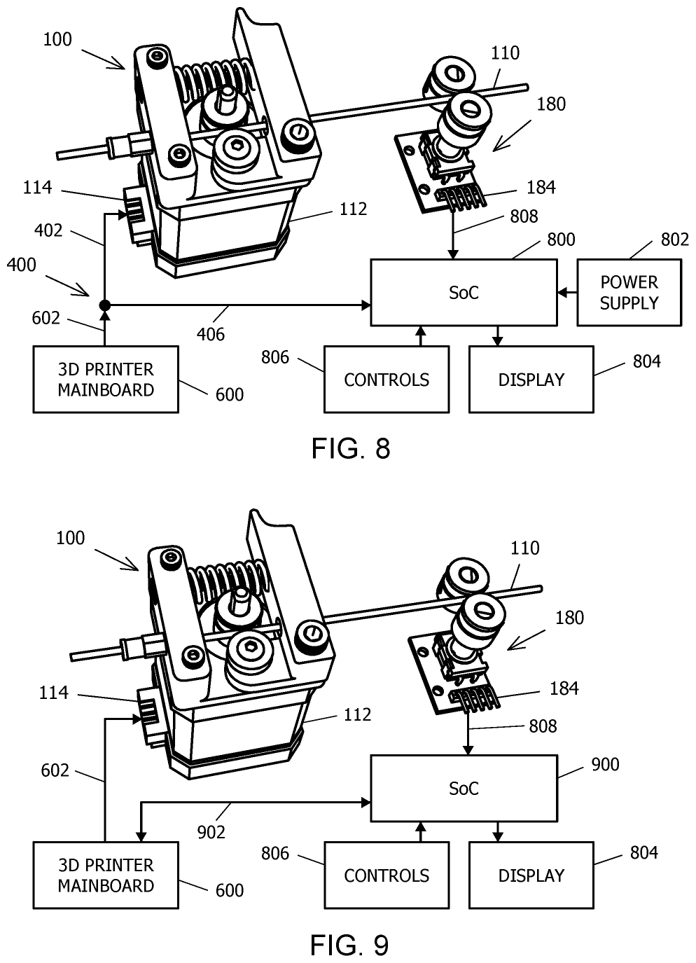

FIG. 8—Cable Splitter Embodiment with Display and Controls

Referring to FIG. 8 as an illustration of an above embodiment, a SoC 800 is electrically connected to motion encoder 180 from connector 184 by wires 808. Cable splitter 400 is employed such that: OEM motor cable 602 is connected from 3D printer mainboard 600 to cable splitter 400; motor-side connector 402 is inserted into motor connector 114 of extruder motor 112; and processor-side connector 406 is electrically connected to SoC 800. This configuration embodies a cable-splitting motor discriminator. A display 804 (for example, LCD, TFT, or OLED) is electrically connected or soldered to SoC 800. Controls 806 (for example, pushbuttons) are also connected or soldered to SoC 800. Controls 806 may be integrated into display 804 if they are resistive or capacitive. Configurations of display 804 and controls 806 are numerous, for example, there may be a menu and sub-menus, and several controls, for example, to calculate E-step on demand and power on/off. Sufficiently, such embodiments achieve actioning by eventually displaying a calculated E-step on display 804.

It should be noted that the particular embodiment depicted by FIG. 8 employs an explicit power supply 802, which is left to a skilled artisan to select and establish. However, the power supply 802 is highlighted in order to contrast it with an alternate source of power, next.

### Actioning—Transmitting E-steps

Actioning in the following embodiments is characterized by transiting a calculated E-step to the 3D printer and system thereof. These embodiments may extend the previous embodiment (Actioning—Displaying E-steps) by adding wireless or wired communication facilities (USB or serial, for example) to a given SoC such that the SoC may transmit well-formed instructions to a given 3D printer mainboard and processor therein in order to read and/or modify an existing E-step value for automatically calibrating a given extruder. For example, issuing a cooperating 3D printer the G-code instruction “M92 E93.0” will update the E-step to a rate of ninety-three steps-per-millimeter.

Generally, 3D printers and other CNC-type machines employ serial communication. Such communication is readily identifiable as the communication initiator is required to set a Baud rate before opening a connection. Serial cables are generally not as common as, say, USB cables, so the present inventor has found that a majority of 3D printers incorporate serial-over-USB. Such an enabled 3D printer has a USB slave controller which identifies itself as a serial communication device to an interrogating USB host controller whence cooperatively connected. As such, some embodiments of this disclosure incorporate a USB host controller (typically in the SoC as an OEM feature) and/or a serial controller. While the term “serial communication” has been used heretofore, it is a surrogate for any reliable communication with a 3D printer and system thereof, even if not yet invented.

### Actioning—Transmitting E-Steps—Serial Transmission Procedure

In an embodiment where an SoC employs a USB host controller (or serial controller), a person skilled in the art should be able to program such an SoC to transmit and update the E-step generally like so: (1) detect the 3D printer; (2) open a serial channel with a common Baud rate (for example, 115200 bps); (3) test the connection by issuing an idempotent G-code instruction like M503 (to report 3D printer settings) and look for expected response strings; (4) try other common Baud rates until successful if not immediately successful; and (5) issue G-code instruction M92 NN.NN where NN.NN represents the calculated E-step. The advantage of such embodiments is that extruder calibration may be semi-automated (or fully automated) owing to the direct communication with the 3D printer.

FIG. 9—Cabled Embodiment with Display and Controls

Referring to FIG. 9 as an illustration of an above embodiment, a SoC 900 is connected electrically to motion encoder 184, display 804, and controls 806 with appropriate wires, cables, and/or soldering as described previously. 3D printer mainboard 600 is directly connected to motor connector 114 via OEM motor cable 602. A differentiating feature of FIG. 9 over FIG. 8 is a USB cable 902. USB cable 902 facilitates bidirectional communication between 3D printer mainboard 600 and SoC 900, as well as supplies power to the embodiment (typically 5V and up to 500 mA) from 3D printer mainboard 600. The advantage of utilizing power provided by USB cable 902, for example, is reducing the need for an internal battery and/or charging circuits. Actioning here proceeds essentially as in the section “Serial Transmission Procedure” above.

Still referring to FIG. 9, it must be noted that display 804 and controls 806 are optional; operation of an “E-step transmitting” embodiment may be directed in whole by a modified 3D printer firmware issuing commands over USB cable 902. For example, someone skilled in the art may craft a non-reserved G-code instruction-issued by such a modified 3D printer firmware—which is understood and executed by SoC 900 to perform an extruder calibration (calculate an E-step and transmit it back).

The advantage of embodiments such as the above is that: a dedicated power supply is not required (reduced hardware); USB communication is typically common to 3D printers; and an embodiment equipped with display 804 and controls 806 may be configured by a skilled artisan to transmit E-steps without modifying any 3D printer firmware (see “Serial Transmission Procedure”).

### Actioning—Self-Updating E-Step

For embodiments of the disclosure where the processor “lives” as part of the 3D printer and system thereof, actioning takes place in computer program code (firmware). In such embodiments, it should be trivial for someone skilled in the art to modify open-source 3D printer code to: (1) initiate an E-step calculation (for one or more extruders); and (2) update the E-step (or E-steps) in the running 3D printer program. For example, existing processor 606 (via firmware) may initiate an extruder recalibration at the start of each layer of the 3D part under fabrication because extruder calibration may be a passive operation (explained shortly). The advantages of such embodiments are: reduced hardware without the need for a display, controls, or a USB/serial cable; and direct, ongoing, and unattended automatic extruder calibration.

### E-Step Calculation Methods

There are two preferred methods disclosed herein to calculate an E-step for a given extruder assembly for a given extrudent in a given environment: active and passive E-step calculation. Variations of these two methods are naturally anticipated.

### Methods—Active E-Step Calculation

In the active calculation method, extrudent is actively extruded for the purpose of extruder calibration. A given embodiment first clears any accumulation counters and/or timers and prepares to observe changes in inputs from a motion encoder and a motor discriminator. The embodiment may: (1) transmit a well-known G-code instruction (transmission methods are described previously) to instruct a 3D printer to extrude a predetermined quantity of extrudent; (2) directly instruct the 3D printer to extrude a predetermined quantity of extrudent via program instructions due to deliberate 3D printer source code modifications; or (3) power the extruder motor directly to extrude a predetermined quantity of extrudent. The latter is possible if the embodiment uses a cable splitter for a motor discriminator with appropriate electrical modifications, though the present inventor recommends modes (1) and (2) which work reliably and safely.

When the extruder assembly begins acting on the instruction(s) above (mode (1) and (2)), all updates from the motion encoder and motor discriminator are recorded in such a way to keep track of how many steps the extruder motor took, and how far the extrudent traveled. This should be continuous and uninterrupted. When the extruder ceases, the steps recorded are divided by the extrudent travel to arrive at the E-step value (typically in steps-per-millimeter). Such a procedure may be repeated to arrive at an average E-step. While valid and a semi-automatic E-step calculation method, this method has the same consequence as the manual method: some extrudent is generally wasted. The present inventor prefers the following method.

### Methods—Passive E-Step Calculation

In the passive calculation method, E-step is calculated during the normal operation of a given 3D printer, meaning the extruder is not directed by the embodiment, so the embodiment passively calculates E-step. The embodiment again clears accumulation counters and/or timers and prepares to observe inputs/values from the motion encoder and motor discriminator. The embodiment may periodically start a timer at a predetermined interval and for a predetermined duration. During this observation window, the embodiment again observes the inputs/values to keep track of absolute extruder motor steps and absolute (cumulative) extrudent travel. Absolute steps and travel are noted because during normal 3D printer operation, some extruders undergo retraction, meaning extrudent may experience positive and negative travel which are both valid for calculating E-step.

It should be noted that a caveat of the passive calculation method is that a situation of no or low extruder activity may be encountered during an observation window. To account for such a situation, a predetermined number of extruder motor steps may be set as a threshold for allowing the calculation of a meaningful E-step. This is discussed in more detail next.

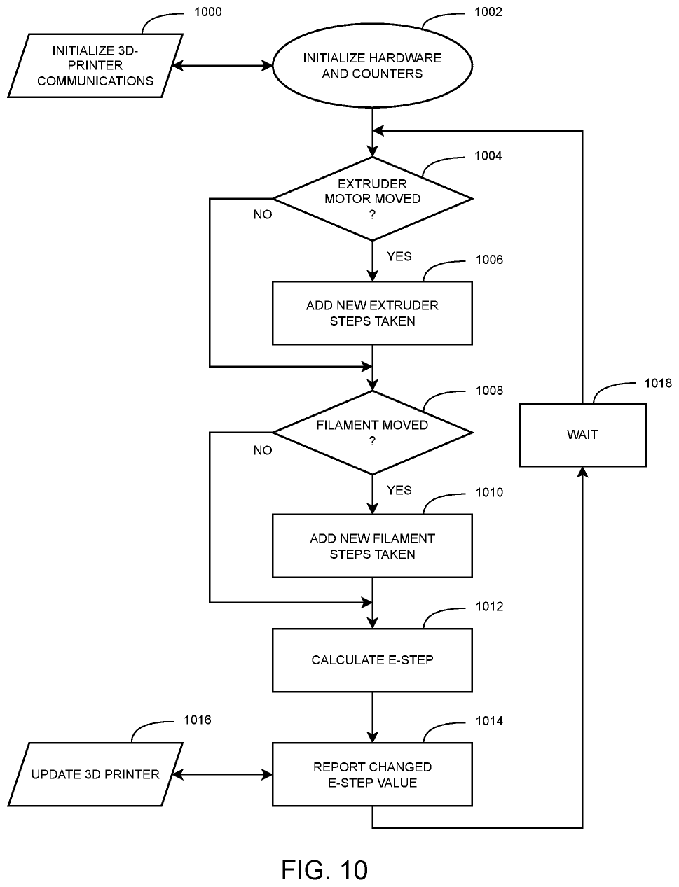

### FIG. 10—Flowchart of Passive E-Step Calculation and Actioning

Referring to FIG. 10 as an illustrative flowchart of the passive calculation method, an implementing embodiment proceeds as follows:
1000—Communications are initialized with a given 3D printer mainboard. This step may be omitted if the embodiment processor is generally also a 3D printer mainboard processor. If the embodiment processor is external to the 3D printer system (for example, as a SoC), initializing of communications consists of establishing a serial connection to the 3D printer mainboard (refer to “Serial Transmission Procedure” steps 1-4);
1002—Embodiment hardware (extrudent meter and/or motor discriminator) is initialized and accumulation counters are cleared;
1004-1006—If the extruder has undergone stepping, add the absolute steps taken (from the motor discriminator) to a first accumulation counter. If the motor discriminator is hardware (for example, a rotary encoder or cable splitter), a person skilled in the art will be able to keep track of every step with, say, hardware interrupts (IRQ and ISR). If the motor discriminator is software, then it is trivial to track each step undertaken;
1008-1010—If the extrudent has undergone travel, add the absolute increments of travel (from the motion encoder of the extrudent meter) to a second accumulation counter. A person skilled in the art will be able to keep track of the absolute increments of travel with, say, hardware interrupts (IRQ and ISR);
1012—An E-step is calculated by dividing the absolute extruder steps taken by the absolute distance the extrudent has traveled during an observation window. This makes sense if the latter is not zero. A person skilled in the art will add checks for division by zero, and checks for meaningful steps taken, say, by programming a predetermined threshold of extruder steps and/or motion encoder increments in order to calculate an E-step. Importantly, the second accumulation counter represents increments of rotation of the motion encoder and must be converted into a physical distance. This is explained with an example in the earlier section “Motion Encoder—Travel Calculation”, but varies between embodiments;
1014-1016—A valid E-step may be available from 1012. If no valid E-step resulted from 1012, then it is said the existing E-step did not change and program flow continues to 1018. If a valid E-step did result from 1012, and it is sufficiently different from the current E-step (for example, exceeding a predetermined absolute difference or delta that a skilled artisan may program), then actioning may take place depending on the embodiment as detailed in the section “Actioning”. Such actions include reporting the E-step in a display, self-updating the E-step value in the 3D printer program, and/or transmitting the E-step to the 3D printer (1016); and
1018—After an actioning has taken place, or if a non-valid E-step resulted from 1012, the procedure waits: (1) a predetermined amount of time; (2) until commanded to continue by instructions or control input; and/or (3) until a predetermined value and/or modulus of a value is reached or exceeded in one or both of the accumulation counters. Procedure flow then may continue to 1004 and repeat.

It must be noted that variations of the above are possible and anticipated. For example, a person skilled in the art may: (1) clear accumulation counters periodically; (2) implement a rolling average; (3) repeat 1004-1012 multiple times to arrive at an E-step average; and/or (4) parallelize 1004-1006 and 1008-1010. The objective of FIG. 10 is to teach a passive E-step calculation method and should not be viewed as a nomination of a best method, or a limitation of scope of the disclosure.

### Summary of Alternative Embodiments

Variations and alternatives of each aspect of embodiments of the present disclosure have been recited thus far. To summarize to the reader the relationships between the aspects, variations of aspects, an extruder assembly, and a 3D printer, the following illustrations are presented. Note, numbered blocks are unnecessary as the reader will recognize each component by name.

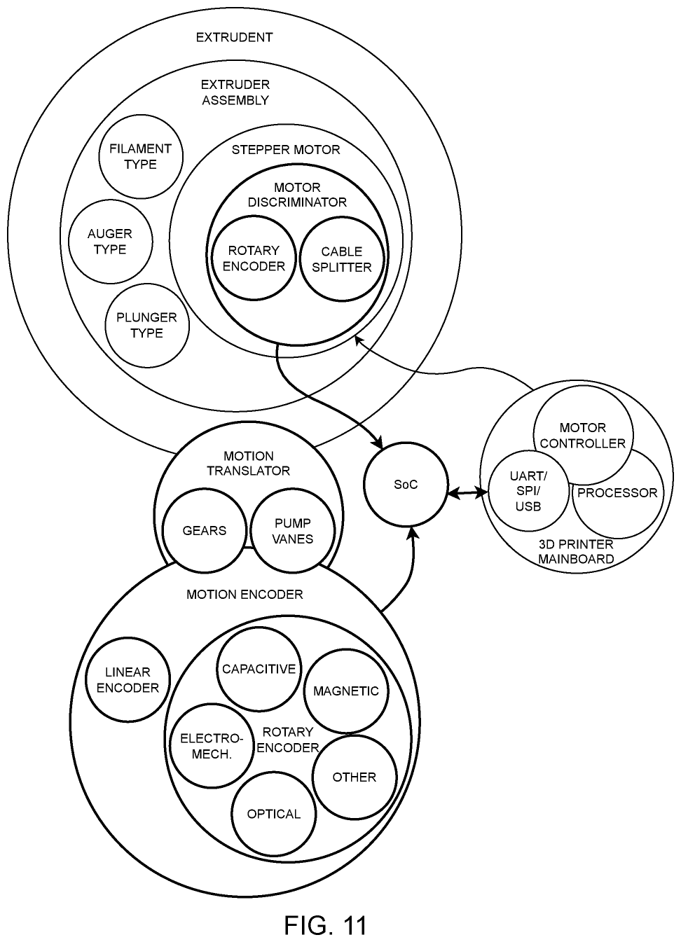

### FIG. 11—Relationships of Aspects 1

FIG. 11 encapsulates the relationships of the aforementioned aspects in a single depiction. Here, a configuration for actioning according to the section “Actioning—Transmitting E-steps” is shown. Such a configuration is bolded (shown in thickened lines) to emphasize: a motion translator; a motion encoder; a motor discriminator; a processor (SoC); and a bidirectional communication with a 3D printer mainboard (actioning) as they relate to an extruder assembly and a 3D printer mainboard. The reader will readily see how the same extrudent is shared by the extruder assembly and the motion translator, for instance.

Within the bold circles, there are sub-configurations as per alternative embodiments disclosed previously. For instance, in the circle titled “motor discriminator”, there are smaller circles for “rotary encoder” and “cable splitter” as those are two of the recited alternatives for motor discriminating.

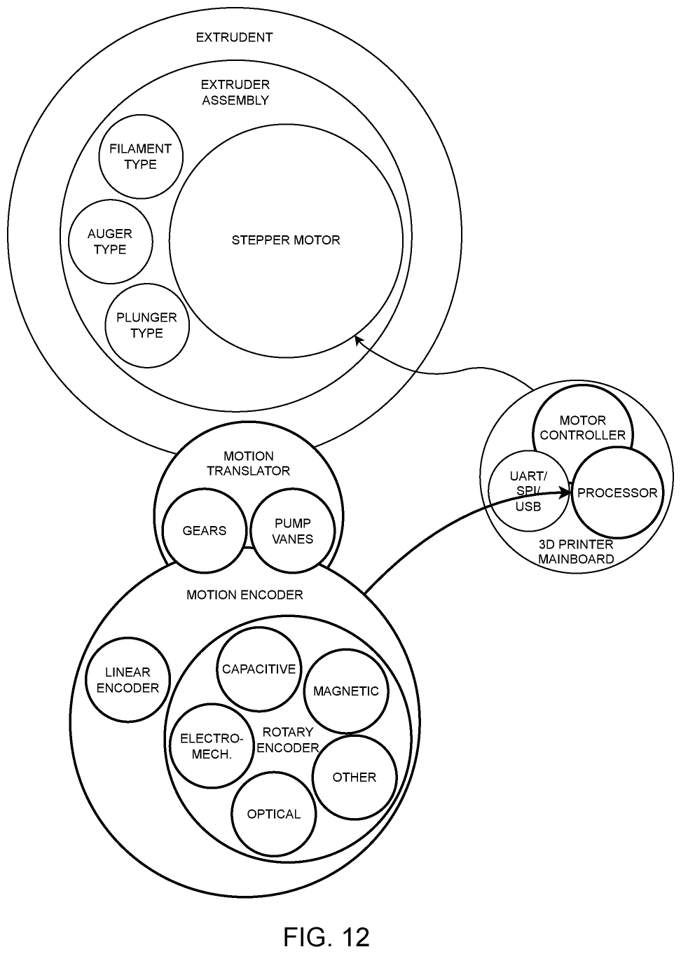

### FIG. 12—Relationships of Aspects 2

FIG. 12 encapsulates the relationships of the aforementioned aspects configured for actioning according to the section “Actioning—Self-updating E-step”. Similar to FIG. 11, such a configuration is again bolded to emphasize: a motion translator; a motion encoder; a motor discriminator (as a 3D printer mainboard's processor and/or motor controller); a processor (as the 3D printer mainboard's processor); and actioning taking place in the 3D printer mainboard wherein an E-step may be calculated an updated in situ. It should be noted that in this configuration there is no hardware motor discriminator since there are no bolded circles on the extruder assembly.

The illustrations of FIG. 11 and FIG. 12 are included to give the reader a clearer understanding of the relationships of the five recited aspects and their variations, and to serve as a guide when interpreting claims.

### CONCLUSION

Accordingly, the reader will see that the extruder calibration apparatus of various embodiments may enable a reliable 3D printer to calibrate automatically or semi-automatically one or more extruder assemblies for a given extrudent in a given environment. Furthermore, in embodiments, the extruder calibration apparatus has the advantages over the manual method in that:
It permits sub-millimeter extrudent metering for accurate E-step calculations over the manual method;
It minimally affects extrudent flow by minimizing drag/resistance on traveling extrudent by way of non-contact encoders;
It provides a portable configuration that may be electrically isolated from a 3D printer wherein only the extrudent and a physical motor discriminator are shared between the apparatus and the 3D printer;
It provides a portable configuration wherein only a data cable (or wireless radio) and extrudent are shared between the apparatus and a 3D printer, such data cable (or wireless radio) allowing automatic E-step updates;
It permits retrofitting of existing 3D printers to enable extruder calibration;
It reduces hardware by permitting a 3D printer mainboard to utilize the existing processor and motor discriminator (as software) so essentially only an extrudent meter and modified 3D printer firmware are required;
It permits unmodified 3D printer firmware in embodiments employing a data cable (for example, a USB cable) and well-known G-code instructions to update E-steps in a 3D printer;
It permits calibration of multiple extruders of a given 3D printer; and
It permits extruder calibration to be continuous and non-interactive with the passive calculation method.

What is claimed is:

1. An extruder calibration apparatus for at least one extruder assembly, the at least one extruder assembly configured to reliably extrude an extrudent, the at least one extruder assembly including an extruder motor, and the extruder calibration apparatus comprising at least one of each of:
a. a motion translator assembly, the motion translator assembly comprising: a stationary machine part; at least one movable machine part; the stationary machine part operatively coupled to the at least one movable machine part; a predetermined regular motion of the at least one movable machine part urged by a regular travel of the extrudent, either directly or indirectly, such that the predetermined regular motion is proportional to the regular travel; and the stationary machine part disposed at a predetermined and fixed distance from the at least one extruder assembly;
b. a motion encoder, the motion encoder comprising: a stationary encoder part; a movable encoder part; the movable encoder part operatively coupled to the stationary encoder part; the motion encoder configured to at least signal each predetermined incremental motive transition on a path representative of the predetermined regular motion; the stationary encoder part operatively coupled to the stationary machine part; and the movable encoder part operatively coupled to the at least one movable machine part;
c. a motor discriminator, the motor discriminator characterized by an electronic device, apparatus, logical system, or computer program code that discriminates or permits discrimination of one or more predetermined steps of rotation of a rotating member of the extruder motor, either observed, inferred, calculated, or extrapolated; and
d. a processor, the processor comprising: at least one interface; the processor operatively coupled to the motion encoder; the processor operatively or logically coupled to the motor discriminator; at least one memory including computer program code; the at least one memory and the computer program code configured to, with the processor and the at least one interface, cause the extruder calibration apparatus to at least calculate an extruder stepping rate of the at least one extruder assembly.

2. The extruder calibration apparatus of claim 1, further comprising: an electronic display, the electronic display operatively coupled to the processor; and an electronic control input, the electronic control input operatively coupled to the processor.

3. The extruder calibration apparatus of claim 2, wherein the electronic control input is capacitive or resistive in nature and is integrated or affixed to the electronic display.

4. The extruder calibration apparatus of claim 1, further comprising a wired or wireless communication module operatively coupled to the processor.

5. The extruder calibration apparatus of claim 4, further configured to operatively establish and maintain a communication channel with a 3D printer, the 3D printer including the at least one extruder assembly, the extruder calibration apparatus configured to at least operatively transmit the extruder stepping rate, or operatively transmit related data to enable calculation of the extruder stepping rate, to the 3D printer via a well-known protocol.

6. The extruder calibration apparatus of claim 1, wherein the motor discriminator or the processor or both of the motor discriminator and the processor are electronically or logically part of a 3D printer and system thereof, the 3D printer including the at least one extruder assembly.

7. The extruder calibration apparatus of claim 6, further comprising at least one additional processor, the at least one additional processor operatively coupled to at least one motion encoder, the at least one additional processor operatively coupled to the first processor.

8. The extruder calibration apparatus of claim 1, wherein the motor discriminator is configured to observe and attenuate a plurality of coil-energizing events, patterns, voltages, or signals related to the operation of the extruder motor of the at least one extruder assembly.

9. The extruder calibration apparatus of claim 1, wherein the motion translator assembly functions predominantly similar in nature to, may be characterized by, or is essentially, an extruder assembly without a driving motor, the extruder assembly without a driving motor for use as a motion translator assembly.

10. The extruder calibration apparatus of claim 1, further comprising one or more toothed gears organized and disposed to improve any of torque, speed, sensitivity, accuracy, or precision of any cooperating mechanical component of the extruder calibration apparatus.

11. The extruder calibration apparatus of claim 1, wherein the motion translator assembly further comprises a spring coupled between the stationary machine part and the at least one movable machine part, the spring biasing the at least one movable machine part toward the extrudent with a predetermined spring force.

12. The extruder calibration apparatus of claim 11, wherein the motion translator assembly further comprises at least one lever, the at least one lever configured and disposed to adjust the predetermined spring force.

13. The extruder calibration apparatus of claim 1, further comprising a housing, the housing predominantly encloses at least the motion translator assembly and the motion encoder.

14. The extruder calibration apparatus of claim 1, wherein the motion encoder further comprises at least one sensor selected from the group consisting of an optical sensor, a magnetic sensor, a capacitive sensor, and an inductive sensor.

15. The extruder calibration apparatus of claim 1, wherein the motor discriminator further comprises a rotary encoder, the rotary encoder operatively coupled to a rotating member of the extruder motor, the rotary encoder disposed internally or externally to the extruder motor, the rotary encoder configured to discriminate each step of the extruder motor.

16. A 3D printer equipped, retrofitted, or provided with at least one extruder calibration apparatus according to claim 1.

17. A 3D printer equipped, retrofitted, or provided with at least one extruder calibration apparatus according to claim 6.

18. A method of calibrating at least one extruder assembly of a 3D printer, the 3D printer including the at least one extruder assembly, the at least one extruder assembly configured to reliably extrude an extrudent, the at least one extruder assembly including an extruder motor, the method essentially comprising:
a. waiting for the at least one extruder assembly to begin to urge the extrudent, or operatively requesting of the 3D printer that the extruder assembly begin to urge the extrudent;
b. fixing at least one predetermined period of observation;
c. metering the travel of the extrudent during the at least one predetermined period of observation for a measure of distance;
d. discriminating and counting the steps of rotation of the extruder motor during the at least one predetermined period of observation for a count of steps;
e. dividing the count of steps by the measure of distance for an extruder stepping rate; and
f. at least one of: operatively reporting the extruder stepping rate to an operator of the 3D printer;
operatively transmitting at least the extruder stepping rate to the 3D printer; operatively transmitting to the 3D printer at least related data to enable calculation of the extruder stepping rate by the 3D printer; and modifying in situ the operation of the 3D printer with the extruder stepping rate.

19. A computer-readable storage medium having stored thereon instructions that, upon execution by at least one processor, cause the at least one processor to perform operations for calculating an extruder stepping rate for at least one extruder assembly of a 3D printer, the 3D printer including the at least one extruder assembly, the at least one extruder assembly configured to reliably extrude an extrudent, the at least one extruder assembly including an extruder motor, the operations essentially comprising:
a. receiving first data, the first data corresponding to at least a representation of a predetermined travel of the extrudent;
b. receiving second data, the second data corresponding to at least a representation of a predetermined rotation amount of the extruder motor; and
c. calculating a third data that represents the extruder stepping rate, the calculating utilizing at least the first data and the second data.

20. The computer-readable storage medium of claim 19, wherein the instructions, upon execution by the at least one processor, cause the at least one processor to perform additional operations of at least one of: operatively preparing the third data for a transmission destined external to the at least one processor and the computer-readable storage medium; operatively modifying the computer-readable storage medium with the third data; and operatively modifying the operation of the 3D printer with the third data.
